(19) United States
(12) Patent Application Publication
(10) Pub. No.: US 2009/0139141 A1
(43) Pub. Date: Jun. 4, 2009

(54) Automatic door opener

(76) Inventors: Michael Fergus MacLeod, Bowmanville (CA); Bejamin Edward Fagan, Lindsay (CA); Mark Bernacki, Oshawa (CA); Matthew R. Van Wieringen, Whitby (CA)

Correspondence Address: Ralph A. Dowell of DOWELL & DOWELL P.C., 2111 Eisenhower Ave, Suite 406, Alexandria, VA, 22314, US

(21) Appl. No.: 11/987,557

(22) Filed: Nov. 30, 2007

(51) Int. Cl. E05F 15/04

(52) U.S. Cl. 49/21; 49/349

(57) ABSTRACT

An automatic door opener is attachable to at least one manual door and an automatic door. The automatic door has a closed position and an open position. The automatic door opener includes an opening actuator, a pressure reservoir and a door activator. The opening actuator is operably connected to the automatic door. The pressure reservoir system is operably connected to the opening actuator, operably connected to the manual door, and operably connected to the automatic door. Movement of the manual door adds pressure to the pressure storage reservoir system. The door activator has an at rest position and an open position whereby pressure from the pressure reservoir system is released to the opening actuator moving the automatic door from a closed position to an open position responsive to movement of the door activator form the at rest position to the open position.

### FIELD OF THE INVENTION

This invention relates to door openers and in particular to automatic door openers which use stored energy from manually moving a door.

### BACKGROUND OF THE INVENTION

In public buildings it is very common that at least one of the doors into the building include an automatic door opener. These automatic doors are particularly useful for handicapped people and the elderly. As well they are useful for other people who have difficulty opening doors because they are with a stroller, their hands are full with packages or there is something other reason making it difficult for that person to open the door. Many of the automatic doors currently available require a fairly high energy input.

Accordingly it would be useful to provide an automatic door that stores energy from people manually moving a door. Further it would be advantageous if an automatic door opener could use energy from different doors being moved manually.

### SUMMARY OF THE INVENTION

The present invention relates to an automatic door opener that is attachable to at least one manual door and an automatic door. The automatic door has a closed position and an open position. The automatic door opener includes an opening actuator, a pressure reservoir system and a door activator. The opening actuator is operably connected to the automatic door. The pressure reservoir system is operably connected to the opening actuator, operably connected to the manual door, and operably connected to the automatic door. Movement of the manual door adds pressure to the pressure storage reservoir system. The door activator has an at rest position and an open position whereby pressure from the pressure reservoir system is released to the opening actuator moving the automatic door from a closed position to an open position responsive to movement of the door activator form the at rest position to the open position.

In another aspect of the invention there is provided a pressure storage system. The pressure storage system includes a plurality of connected air tanks whereby when pressure is being stored and the pressure in each of the plurality of air tanks reaches a predetermined pressure level pressure will then be stored in the next adjacent air tank in the series of the plurality of air tanks and wherein pressure is provided by the first of the series of the plurality of air tanks.

Further features of the invention will be described or will become apparent in the course of the following detailed description.

### BRIEF DESCRIPTION OF THE DRAWINGS

The invention will now be described by way of example only, with reference to the accompanying drawings, in which:

FIG. 1 is a front view of the automatic door opener constructed in accordance with the present invention and installed over a hinged type door;

FIG. 2 is a front view of the mechanical portion of the automatic door opener;

FIG. 3 is a side view of the mechanical portion of the automatic door opener of FIG. 2;

FIG. 4 is a top view of the mechanical portion of the automatic door opener of FIG. 2 and showing the door closed;

FIG. 5 is a top view of the mechanical portion of the automatic door opener similar to that shown in FIG. 4 but showing the door opened at about a 15 degree angle;

FIG. 6 is a top view of the mechanical portion of the automatic door opener similar to that shown in FIG. 4 but showing the door opened at about a 45 degree angle;

FIG. 7 is a top view of the mechanical portion of the automatic door opener similar to that shown in FIG. 4 but showing the door opened at about a 90 degree angle;

FIG. 8 is a top view of a second alternate mechanical portion of the automatic door opener, showing a cylinder fixed to the base and using a guide track and roller;

FIG. 9 is a top view of a third alternate mechanical portion of the pneumatic automatic door opener, showing a chain and sprocket arrangement;

FIG. 10 is a top view of a fourth alternate mechanical portion of the pneumatic automatic door opener, showing a belt arrangement;

FIG. 11 is a top view of a fifth alternate mechanical portion of the pneumatic automatic door opener, showing a linear gear arrangement;

FIG. 12 is a top view of a sixth alternate mechanical portion of the pneumatic automatic door opener, showing a single lever arm and a roller arrangement;

FIG. 13 is a top view of a seventh alternate mechanical portion of the pneumatic automatic door opener, showing the pneumatic cylinder directly connected to the door;

FIG. 14 is a top sectional view of a pneumatic cylinder for use in the mechanical portion of the door opener of the present invention, showing a single cylinder;

FIG. 15 is a top sectional view of an alternate pneumatic cylinder for use in association with the mechanical portion of the door opener of the present invention, showing a double cylinder.

FIG. 16 is a schematic diagram of the pneumatic system including the pressure reservoir system of the door opener of the present invention; and

FIG. 17 is a schematic diagram of the pneumatic system including the pressure reservoir system similar to that shown in FIG. 16 but showing two cylinders;

FIG. 18(a) to FIG. 18(d) are schematic diagrams of alternate storage tank configurations all for use with the pressure reservoir systems shown in FIGS. 16 and 17 wherein (a) is a single tank configuration, (b) is a double tank configuration (c) is a triple tank configuration, and (d) is a four tank configuration;

FIG. 19 is a schematic diagram of pneumatic system including the pressure reservoir system similar to that shown in FIG. 16 but showing pressure input from an external pumping mechanism;

FIG. 20 is a front view of rotary door having a pumping mechanism connected thereto for providing pressure to the pressure reservoir system of the present invention;

FIG. 21 is a top view of the pumping mechanism of FIG. 20;

FIG. 22 is schematic diagram of the pumping mechanism of FIG. 21;

FIG. 23 is a top view of an alternate pumping mechanism for use with a rotary door similar to that shown in FIG. 21 but showing a direct connection to the cylinders;

FIG. 24 is a top view of another alternate pumping mechanism for use with a rotary door similar to that shown in FIG. 21 but showing a rotary pump;

FIG. 25 is a top view of another alternate pumping mechanism for use with a rotary door similar to that shown in FIG. 24 but showing a rotary pump with gears; and

FIG. 26 is a front view of a multi-bank door configuration for providing pressure to an automatic door constructed in accordance with the present invention.

### DETAILED DESCRIPTION OF THE INVENTION

The operation of the door by able-bodied persons (applying manual force to open the door as with any typical door) will be referred to as “manual operation”. The automatic opening of the door by individuals requiring assistance, activated by pressing an opening button will be referred to as “automatic operation”.

A device of the present invention is for automatically opening doors for physically challenged people or other individuals requiring assistance, which is self powered by storing energy during the manual opening motion of the door by use of able-bodied persons.

Preferably the device is pneumatically driven with the use of one or more pneumatic cylinders. In manual operation, the opening motion of the door causes one or more pneumatic cylinders to compress air into an air tank system. Once the applied opening force on the door is removed, the door slowly returns to the closed position in a controlled fashion preferably with the use of a damper and spring. Repetitive manual operations will increase tank system pressure to a preset maximum after which excess pressure simply vents to atmosphere.

In automatic operation, the device is activated by the pressing of a pneumatic valve which passes compressed air from the storage tank system to a spring returned-pilot operated two position valve. This pilot operated valve then changes to position two and passes air from the storage tank system to the drive cylinder(s), which causes the door to open. The device stays in this state (door held open) for a preset amount of time until a pneumatic timer (or controlled bleed) in the activation valve circuit eventually causes a drop in pressure which reverts the pilot operated valve back to position one, and allows the door to close.

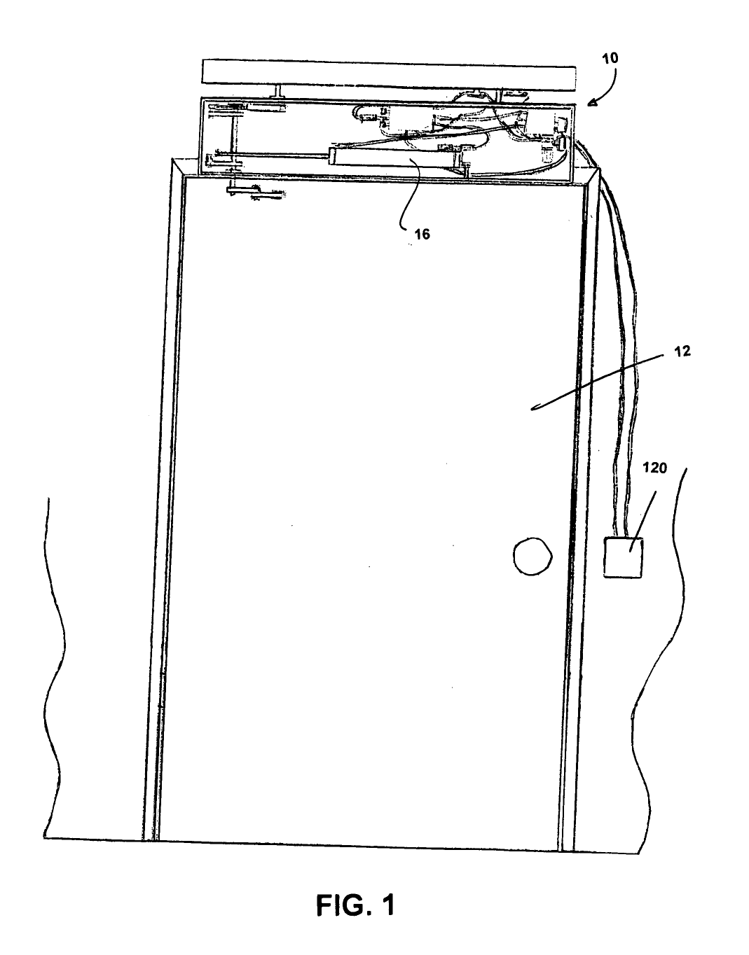

Referring to FIG. 1, the door opener 10 of the present invention is shown attached to a door 12. The door opener 10 includes a mechanical system and a pressure reservoir system. A door activator or push button 120 has an at rest position and an open position whereby pressure from the pressure reservoir system is released to the mechanical system thereby moving the automatic door from a closed position to an open position responsive to movement of the door activator from the at rest position to the open position.

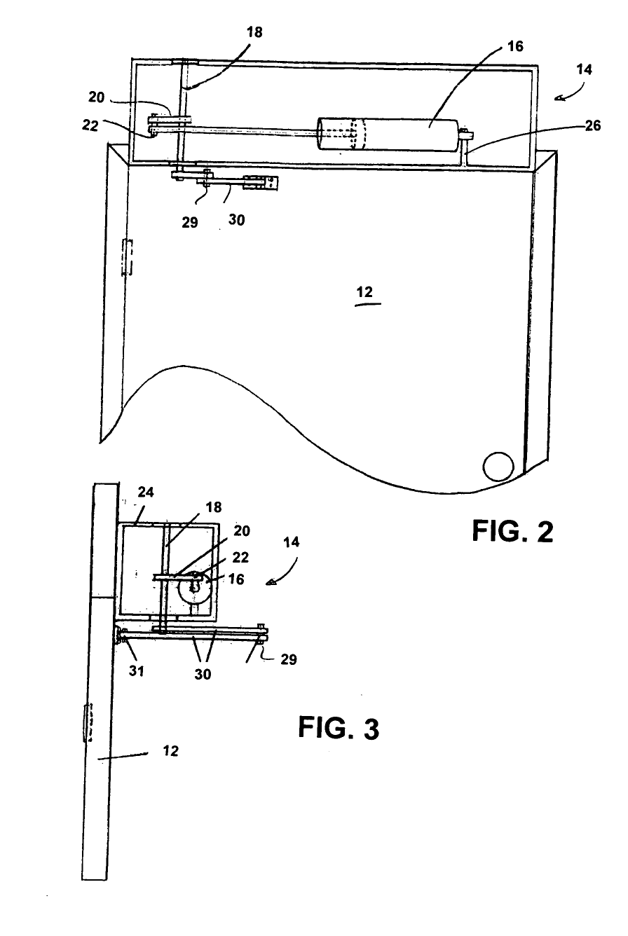

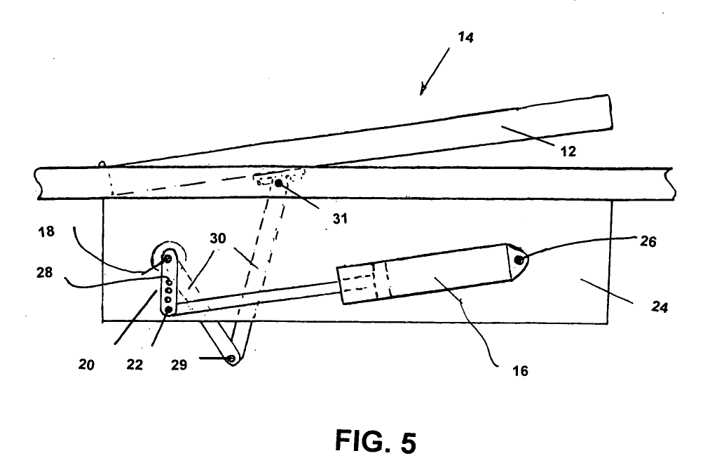

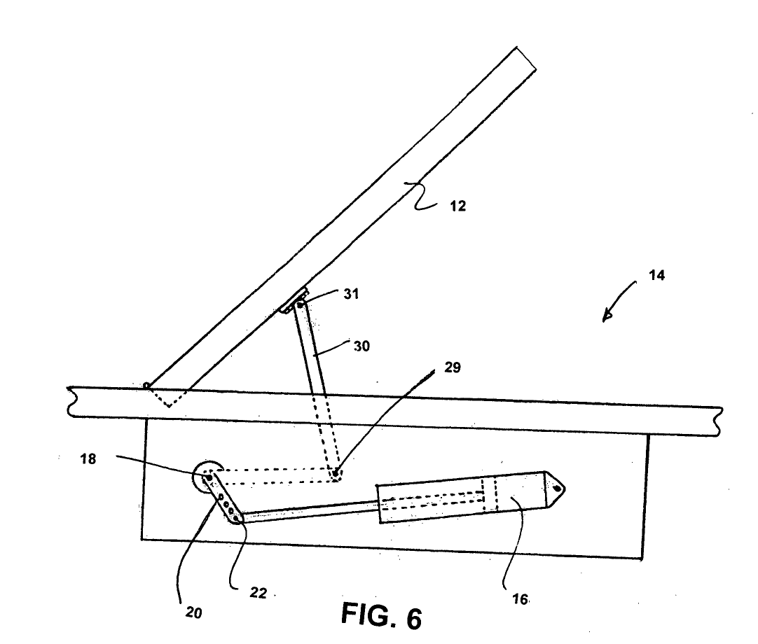

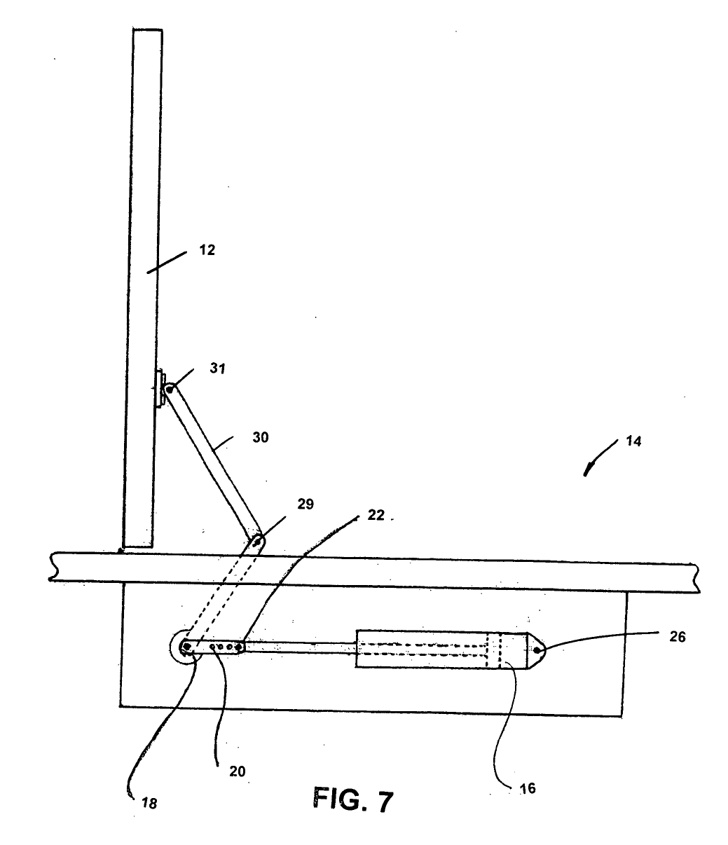

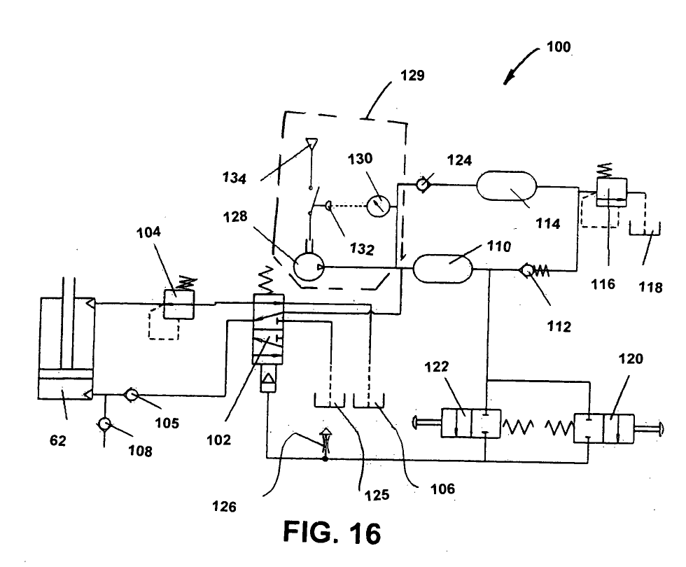

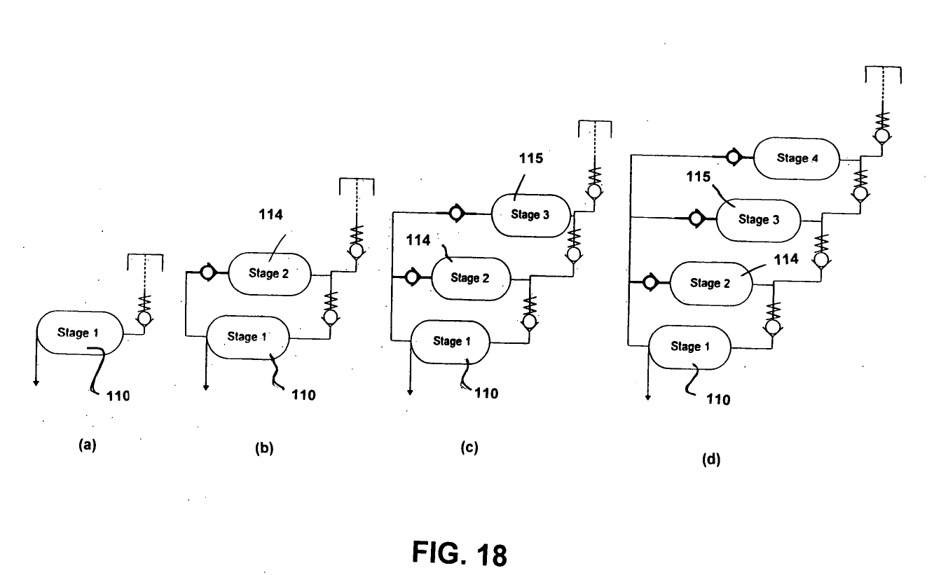

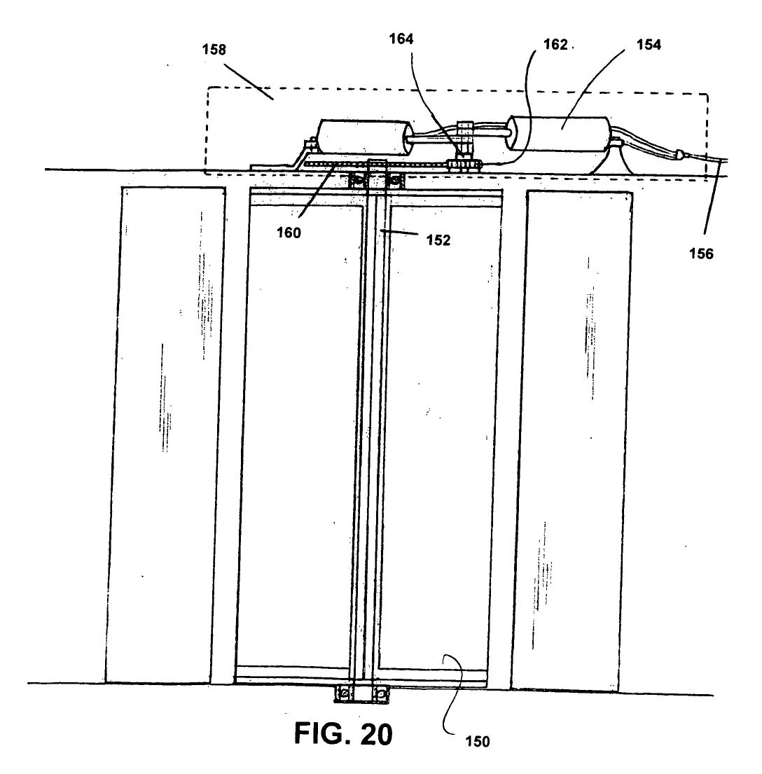

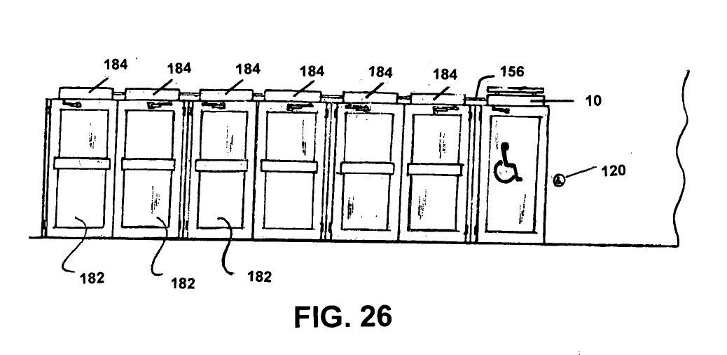

The mechanical system and variations on the system and components of the system is shown in FIGS. 2 to 15. Alternate pressure reservoir systems are shown in FIGS. 16, 17 and 19 and a variation on the multiple storage tanks is shown in FIG. 18. Embodiments that use a rotary door for providing pressure to the pressure reservoir system are shown in FIGS. 20 to 25 and an embodiment which utilizes a bank of doors for providing pressure to the pressure reservoir system is shown in FIG. 26. In the embodiments shown in FIGS. 1 to 15 the manual door used to store energy is the same as the automatic door that opens responsive to the door activator 120 being moved. In contrast in FIGS. 20 to 26, the manual doors used to store energy are not the same as the automatic door that is opened responsive to the door activator 120.

Referring to FIGS. 2 to 7 the mechanical system is shown generally at 14. The pressure reservoir system (valves, lines, regulators, tank system,etc.) is not shown in FIGS. 2 to 13 for clarity of the mechanical system 14. The automatic door 12 has a closed position and an open position. The mechanical system 14 includes an opening actuator which is operably connected to the automatic door 12. The pressure reservoir system is operably connected to the opening actuator, operably connected to the manual door, and operably connected to the automatic door. Movement of a manual door adds pressure to the pressure storage reservoir system. The invention first converts motion from a manual door to pressure and stores that pressure to be used in association with an automatic door. In the embodiment shown in FIGS. 2 to 7 linear motion of the cylinder(s) 16 is converted to rotational motion of the output shaft 18, then a connection between the output shaft 18 and the door 12 converts the rotation of the shaft 18 to the sweeping of the door 12.

As depicted in the invention lever 20 is fixed to the output shaft 18. One end of the cylinder(s) 16 is attached to this lever 20 using a pivot 22, and the other end of the cylinder(s) 16 is attached to the base 24 also with a pivot. Thus, when the cylinder(s) 16 lengthens or shortens, it causes the output shaft 18 to rotate, and vice versa. The connection point of the cylinder(s) 16 to the lever 20 can be changed, allowing for different output torques from the same cylinder(s) 16. Lever 20 is provided with a plurality of connection apertures 28 to provide different connection locations. This conversion of the linear motion of the cylinder(s) 16 to rotation motion of the output shaft 18 can be achieved in numerous ways as shown in FIGS. 2 through 13 and described below.

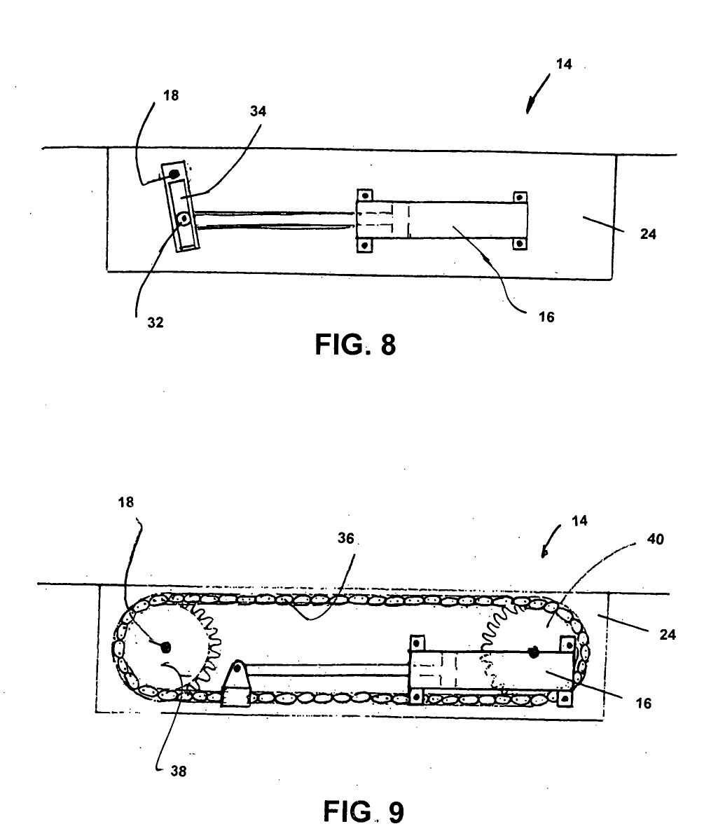

In the embodiment of the invention shown in FIGS. 2 to 7, connected to the rotating output shaft 18 is a simple two bar linkage 30. The two arms of the two bar linkage are pivotally attached together at pivot 29. This linkage 30 is connected to the door 12 at pivot 31. When the output shaft 18 rotates, it moves the linkage 30 in such a way that it forces the door 12 open, or vice versa. There are numerous variations in which the output shaft 18 could be connected to the door 12 as shown in FIGS. 8 and 13.

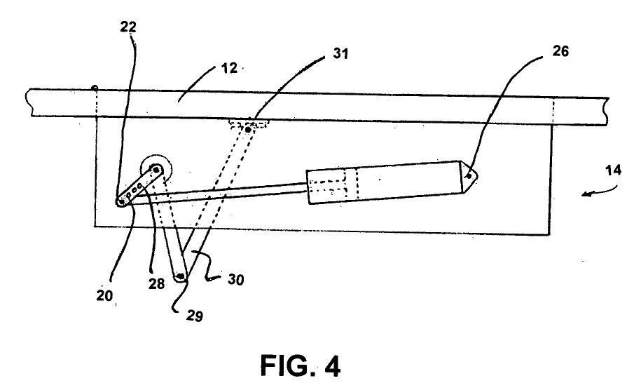

Referring to FIGS. 3 through 7, the figures are simplified to show only the variation in converting linear motion of the cylinder(s) 16 to rotational motion of the output shaft 18.

The embodiment shown in FIG. 8 is similar to that shown in FIGS. 2 to 7 in regard to the lever arm 20 design, except the cylinder(s) 16 is fixed to the base 24 and cannot rotate. The free end of the cylinder(s) 16 has a roller 32 that can run freely along the length of the roller guide 34. The roller guide 34 is fixed to the output shaft 18. In this configuration, the extension of the cylinder(s) 16 causes the rotation of the output shaft 18, and vice versa. With this design, the output torque and stroke of the output shaft 18 can be adjusted by changing the mounting position of the cylinder(s) 16 to the base 24.

The embodiment shown in FIG. 9 uses a loop of chain 36 around two sprockets 38, 40. Sprocket 38 is fixed to the output shaft 18, and sprocket 40 is free running. One end of the cylinder(s) 16 is fixed to the chain 36, and the other end is fixed to the base 24 in such a way that extension of the cylinder(s) 16 causes the rotation of the output shaft 18 and vice versa.

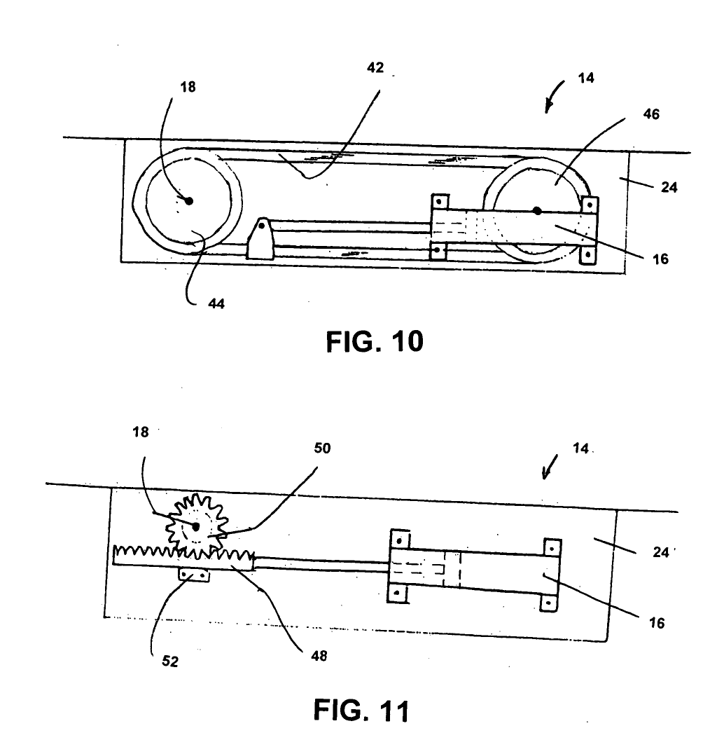

The embodiment shown in FIG. 10 is similar to the one shown in FIG. 9 but uses a belt 42 and pulleys 44, 46 instead of a chain 36 and sprockets 38, 40. Pulley 44 is fixed to the rotating output shaft 18, while pulley 46 is free running.

The embodiment shown in FIG. 11 uses a linear gear 48, fixed to the moving end of the cylinder(s) 16, with the other end of the cylinder(s) 16 fixed to the base 24. Fixed to the output shaft 18 is a spur gear 50, which meshes with the linear gear 48, held in place by guide block 52. In this design, the expansion of the cylinder(s) 16 causes the linear gear 48 to rotate the spur gear 50, causing the output shaft 18 to rotate, and vice versa.

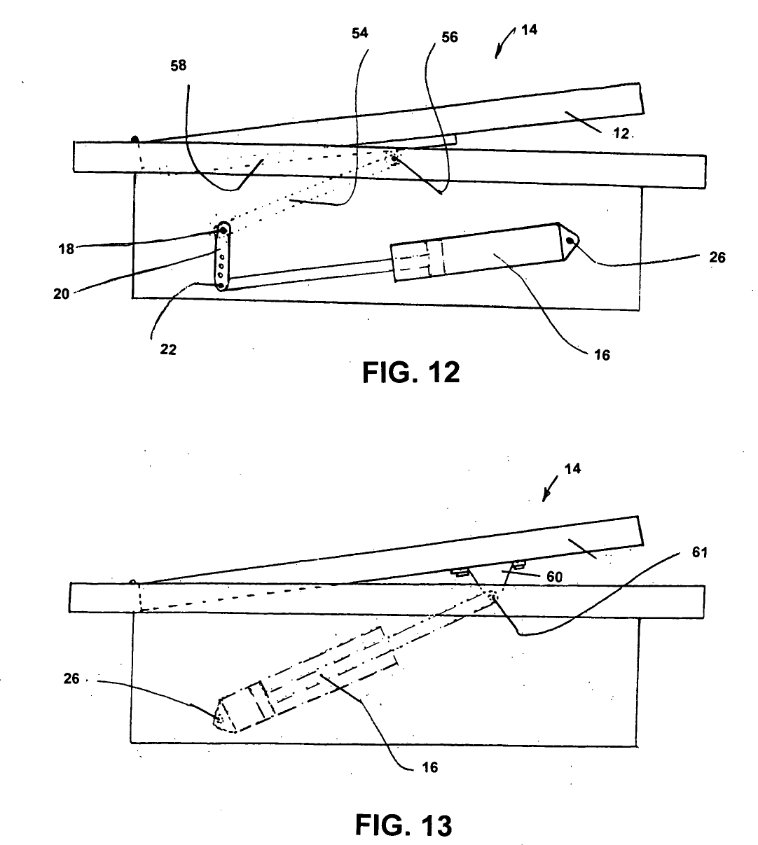

The embodiment shown in FIG. 12 uses a single lever arm 54 fixed at one end to the output shaft 18, and a roller 56 at the other end. The roller 56 is free to move along a guide track 58 which is fixed to the door 12. In this way, rotation of the output shaft 18 as well as the lever arm 54 to which it is fixed, causes the roller 56 to apply a force to the door 12 which opens it, and vice versa.

The embodiment shown in FIG. 13 is direct connection of the cylinder(s) 16 to the door 12. In this simplified arrangement, no mechanism for converting linear motion to rotational motion of the output shaft 18 is needed. In this design, one end of the cylinder(s) 16 is connected to a bracket 60 on the door 12 by a pivot 61, and the other end of the cylinder(s) 16 is attached to the base 24 with another pivot. Thus, when the cylinder(s) 16 lengthen, an opening force is applied directly to the door 12, and vice versa. Note that this arrangement differs from the rest because the cylinder(s) 16 are mounted beneath/external to the base 24, so as to be in line with the bracket 60 which is mounted on the face of the door 12.

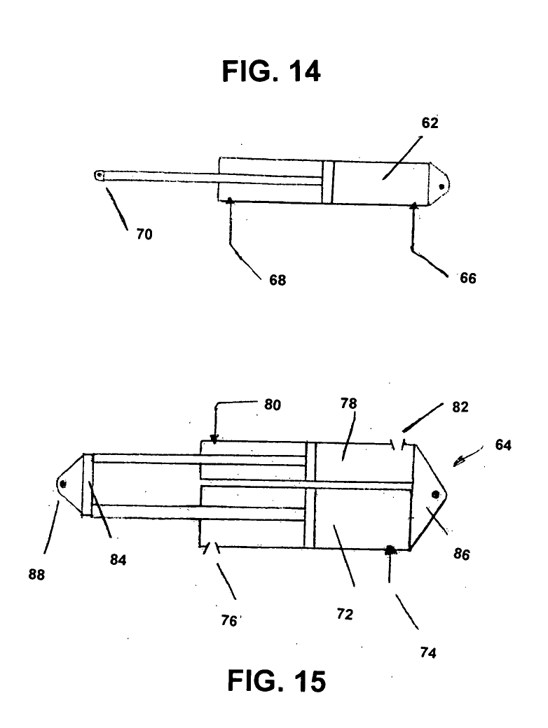

Preferably the cylinders 16 are pneumatic cylinders and the system can function with either single pneumatic cylinders 62 shown in FIG. 14 or dual pneumatic cylinders 64 shown in FIG. 15. Using dual cylinders is advantageous because the drive cylinder and the compressing cylinder are separate, allowing different cylinder sizes for each. A larger diameter compressing cylinder will store more mass of air into the tank system with every stroke, making the system more efficient. The pneumatic circuit is the same for single cylinder and double cylinders, the only difference is how the air lines are connected to the cylinder(s).

When a single cylinder 62 is used, a double acting cylinder is required. The compressing side of the cylinder 62 which pumps air into the tank system is connected to the pressure reservoir system or pneumatic circuit by port 66. The drive side of the cylinder 62 is connected to the pressure reservoir system or pneumatic circuit by port 68. The cylinder 62 is connected to the opening mechanism at the rod end 70.

When using dual cylinders 64, two single acting cylinders are required. The compressing cylinder 72 is connected to the pneumatic circuit at port 74, while the other side of the piston is vented to atmosphere at all times by open port 76. The drive cylinder 78 is connected to the pneumatic circuit at port 80, while the other side of the piston is vented to atmosphere at all times by open port 82. Both cylinders are rigidly connected by brackets 84, 86 in such a way that both stoke at the same time. The dual cylinders are connected to the opening mechanism at a single pivot 88.

The door opening device 10 includes the mechanical system 14 and the pressure reservoir system 100. Preferably the pressure reservoir system is a pneumatic circuit shown in FIG. 16. The system 100 can operate in two modes, manual and automatic.

In manual mode the 5/2 pilot operated spring return valve 102 is in the position shown in FIG. 16.

When the door is opened in manual mode, double acting cylinder 62 sweeps inward filling with air from atmosphere through pressure regulator 104, pilot operated spring return valve 102, and vent 106. Air on the other side of the piston is forced through check valve 105, pilot operated spring return valve 102, and into stage one storage vessel 110.

Upon door closure the double acting cylinder 62 sweeps outward forcing air through pressure regulator 104 and pilot operated spring return valve 102 to atmosphere at vent 106. Low pressure on the other side of the piston draws air in from atmosphere through check valve 108, filling the double acting cylinder 62.

As manual openings are repeated, pressure builds in stage one storage vessel 110 until it exceeds a preset pressure, and begins to force air past spring loaded check valve 112, and into stage two storage vessel 114. This multiple tank arrangement allows the system to achieve operating pressure with less air mass while maintaining higher amounts of storage volume. As pressure surpasses the preset level in stage two storage vessel 114, air can be relieved through relief valve 116 and vented to atmosphere through vent 118.

Automatic mode is initiated by activating either one of the two wall mounted 2/2 push button spring return valves 120 or 122 which pass supply air from storage to 5/2 pilot operated spring return valve 102. Supply air is available from either stage one storage vessel 110 directly, or stage two storage vessel 114 through check valve 124. In this configuration, supply air pressure is always the higher pressure of the two stages. Once activated, pilot operated spring return valve 102 switches to its second position and passes supply air from storage through pressure regulator 104. From pressure regulator 104, air pressure flows into double acting cylinder 62 which sweeps inward, automatically opening the door. During inward sweeping of cylinder 62, air trapped on opposite side of the piston is directed through check valve 105, pilot operated spring valve 102, and vented to atmosphere through vent 125. The door remains open for a time period controlled by bleed valve 126, which eventually causes a pressure drop which switches pilot operated spring return valve 102 back to initial position, releasing pressure from the double acting cylinder 62 through vent 106 to atmosphere. The system is now back in manual mode.

An optional back up electric system 129 is shown with a dotted line. Optional electric powered air compressor 128 provides redundancy in the event of air pressure falling below a preset pressure threshold, measured by pressure gauge 130. In a low pressure situation, pressure gauge 130 sends low pressure signal to pressure switch 132. Pressure switch 132 completes circuit from electric power source 134 to air compressor 128. The compressor 128 will run until pressure supply pressure reaches preset pressure threshold. In situations when sufficient ratio of manual to automatic door openings are maintained, the compressor will not be activated.

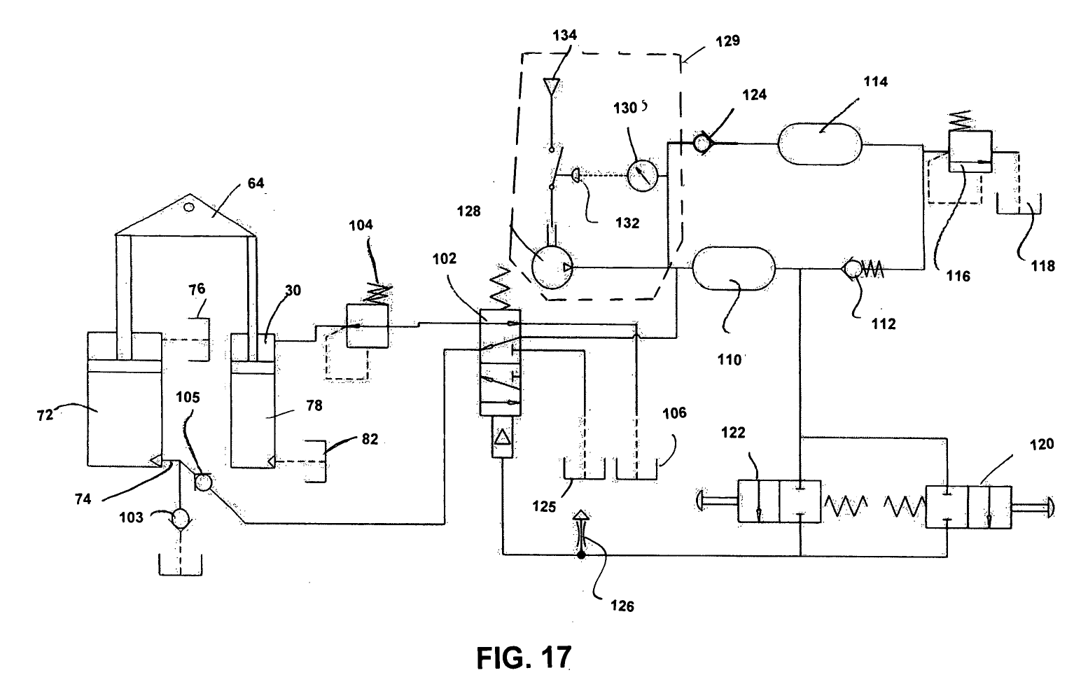

As discussed above rather than a cylinder 16 being a single cylinder 62 it can be a dual cylinder 64 with two single acting cylinders. In FIG. 17, the circuit described above and shown in FIG. 16 is modified to use a dual cylinder 64. All of the rest of the circuit is as described above.

Preferably the automatic door opener of the present invention utilizes a multi-stage compressed air storage tank system. The advantage over a standard single stage storage tank system is that with a multi-stage system, the time required to reach required operating pressure is reduced. The larger the number of stages, the faster the system will reach operating pressure, and the only limiting factor as to how many stages can be used is simply cost of components and physical space. The advantages of the multi-stage storage tank system is not unique to this invention, but can be applied to many different devices which utilize compressed air. FIGS. 16 and 17 each show a two stage system, however this could be modified to include different numbers of storage tanks as shown in FIG. 18.

As with any compressed air storage system, a certain volume of tank will be required to maintain desired operating performance of the system. Also, in order to operate the device to which the compressed air is supplied, typically a minimum pressure level is required. Therefore in a single stage storage system, the entire volume of the tank must be compressed to operating pressure before the device will operate, which can sometimes be time consuming, even if only a small percentage of the stored air pressure is required for a single cycle of the operated device.

With a multi stage tank system, total tank volume is divided into smaller volume stages, which fill in sequence, only beginning to fill the next stage once the previous stage is at operating pressure. Each stage after the first stage of a multi-stage system feeds its supply air through a check valve and to the first stage of the tank system. In this configuration, stage one tank will always be maintained at the highest pressure existing anywhere in the multi-stage system. For this reason, the supply air of the overall system is always delivered from stage one tank.

Any device which uses a compressed air storage system and is used intermittently will see advantages of a multi-stage storage system, and increasing the number of stages decrease the time required to reach operating pressure of the system.

If additional overall storage capacity is desired, additional stages can be easily added. See FIG. 18 for schematic examples of single, double, triple, and quad stage tank systems.

When considering the pneumatic circuit shown in FIGS. 16 and 17, if the door is operated and pressure is reduced in the first tank 110, but tank 110 still has higher pressure than tank 114, then another operation of the door will still use pressure from tank 110. If pressure in tank 110 is reduced to a level LOWER than tank 114 (and/or any other tank), then air will automatically equalize from tank 114 (and/or any other tank) into tank 110.

In the multi tank system, the output of every tank AFTER the first tank 110 (O2, O3, O4) flows outward through a check valve and is connected to the output/input of the first tank (O/I1). Because of this arrangement, if pressure in tank 110 is depleated below the pressure of any other tank in the system, air from those higher pressure tanks will automatically equalize into tank 110.

The output/input of tank 110 (O/I1) feeds the working components of the door system, but also acts as the input to the entire tank system. Noting the direction of the check valves, you will see that as compressed air is delivered to the tank system at O/I1, it is routed first through tank 110, then through tank 114, then to tank 115, etc. However, the movement of air upwards to the higher tank can ONLY happen once the lower tank is filled to capacity.

This arrangement is unique because tank 110 (where the working system delivers and draws air from) will always remain at the highest pressure of anywhere in the tank system, and still has access to the additional storage capacity of all the upstream tanks. This multi tank storage system is useful on any application that uses compressed air as a working fluid (not just our door opener), and it will always increase its performance compared to a standard single tank.

Because the device stores energy from manual operation for use in automatic operation, no other energy sources are required, as long as there are a sufficient percentage of manual operations to automatic operations. Therefore this automatic door opener device can be installed on nearly any door without the need for connection to a power source, and will operate during power outages or if power is not available on site. Also, because there are no electrical components in the device, it is safe to use in environments where flammable substances may be present necessitating the use of spark free equipment.

If a higher level of redundancy is required, a small auxiliary electric compressor can be included to maintain required operating pressure in the rare event that the ratio of manual to automatic operations drops below a critical level. It is important to note that in this arrangement, the compressor is not the primary source of energy, but it simply acts as a backup to the main energy storage system.

In manual operation, the device functions similar to a conventional damped door. The able-bodied user simply applies a force to open the door, walks through the doorway, removes the opening force, and the door slowly returns to the closed position.

In automatic operation, the person requiring assistance actuates the door by pressing a wall-mounded button, and the door automatically opens. The door remains open for a preset amount of time allowing the user to move through the doorway, then it slowly returns to the closed position.

Many buildings with high traffic flow use rotary doors and or banks of standard doors at the entrance/exits. In most cases, rotary doors and multi door banks will be accompanied by one or more standard swinging doors on either side equipped with automatic opening functions to assist physically challenged persons. The regenerative automatic door opener is ideally suited to entrances like these because the rotary door and multi door banks can be a good source of compressed air when equipped with a pumping mechanism, and will provide a high volume of compressed air due to the high traffic flow.

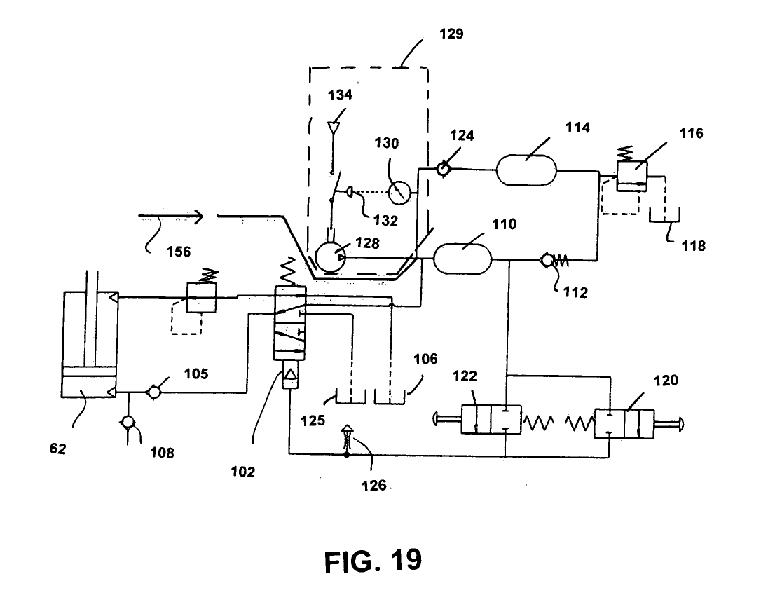

A pumping mechanism can come in various forms depending on the application, but all perform the same basic function. When manually opened, they simply supply compressed air directly to the storage tank for the automatic door, increasing the rate at which the automatic door opener can operate. Because these pumping mechanisms do not have automatic opening functions, their pneumatic systems are very simple compared to the automatic opening system. Only one air line runs from each pumping door, and it connects to the input of tank one in the automatic door opener tank system. Because of the increased air supply in this configuration, larger capacity or more numerous storage tanks can be utilized. The point at which the air line running from the rotary door or multi door bank connects to the standard system is shown in FIG. 19 at 156.

A typical rotary door 150 is shown with the main rotation shaft 152 connected to a pumping mechanism which in the embodiment shown in FIG. 20 is a geared crank connection with dual cylinders 154. The pumping mechanism 158 is outlined in a dotted line because it can be configured in various ways. However all of the rotary door and multiple door embodiments are connected to the main rotation shaft 152 in the same way. As the door 150 is rotated, the main shaft turns the pumping mechanism and sends compressed air down the supply line 156 to the automatic door opening mechanism downstream.

Many devices can be used to compress the air from the rotation of the shaft, two of which are covered here: cylinders, and rotary pumps. There are also many possible designs of the mechanical connection between the rotating shaft and the pumping mechanisms, three of which are covered here: direct shaft connection, direct crank connection, and geared crank connection.

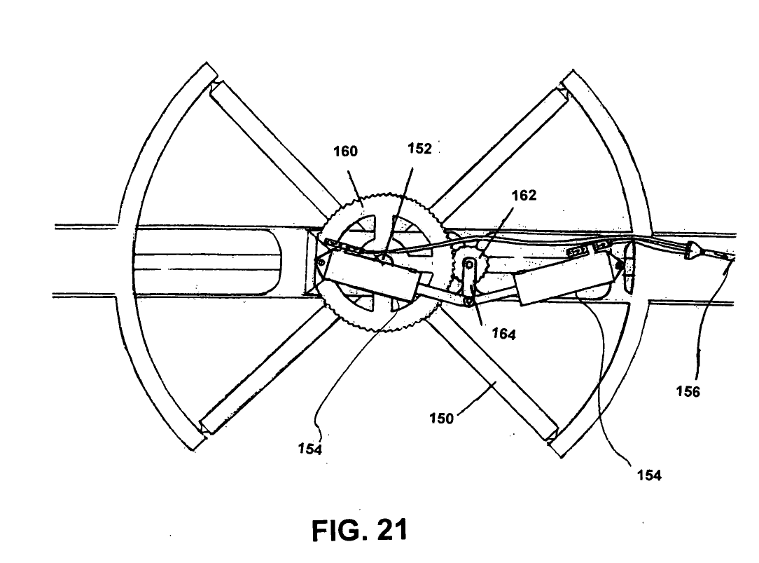

Referring to FIGS. 20 and 21, a large spur gear 160 is fixed to the main rotation shaft 152. When the door 150 is rotated, main shaft 152 rotates spur gear 160, which rotates a smaller spur gear 162. Fixed to spur gear 162 is a crank 164 which rotates and causes cylinders 154 to stroke, thus compressing air in the supply line 156. In this configuration spur gear 162 makes 4 revolutions for every revolution of the door 150. This causes the cylinders 154 to stroke through their compression stroke once from each 90 degree rotation of the door 150. By changing the gear ratio between the two spur gears 160 and 162, a different number of compression strokes can be attained per rotation of the door 150. By altering the length of the crank 164, the stroke length of the cylinders 154 can be changed. This design can also function with only one single cylinder, or any combination of multi cylinders.

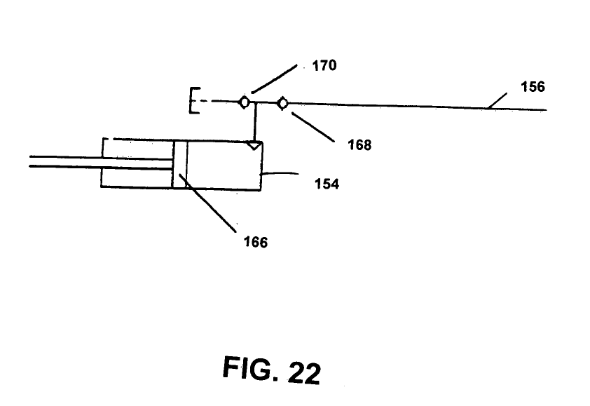

The pneumatic schematic is shown in FIG. 22. As the piston 166 is forced inward, pressure in the cylinder 154 rises and is forced past downstream check valve 168. From check valve 168 the compressed air moves down the supply line 156 eventually entering the storage tank (not shown). When the piston 166 moves outward, air pressure in the cylinder 154 drops drawing air past upstream check valve 170, filling the cylinder 154. The cylinder used is a single acting cylinder which is vented at one end. This schematic is identical for all cylinders used in all pumping mechanism designs.

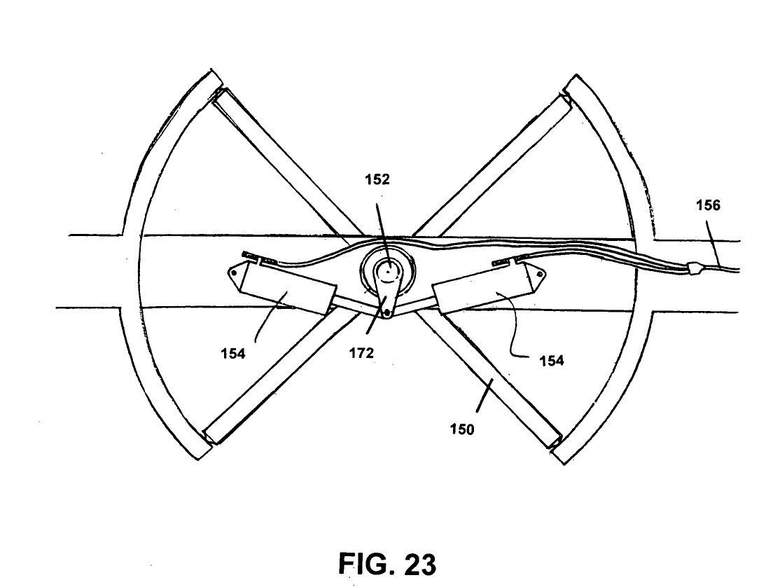

In the embodiment shown in FIG. 23, the crank 172 is fixed directly to the main rotation shaft 152. When door 150 rotates, the crank 172 causes the cylinders 154 to stroke feeding air down supply line 156. With this design, the pistons in cylinders 154 will each cycle through one compression stroke for each 360 degree rotation of the door 150. Changing the length of the crank 172 will change the length of the stroke of the cylinders 154.

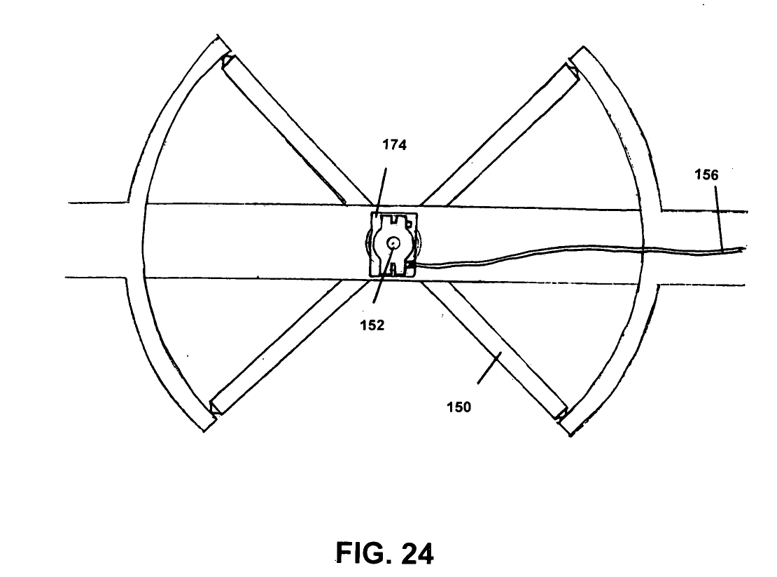

In the embodiment shown in FIG. 24, a rotary pump 174 is directly connected to the main rotating shaft 152. When the door 150 is rotated, the pump 174 rotates at the same RPM causing air to be compressed and fed down the supply line 156.

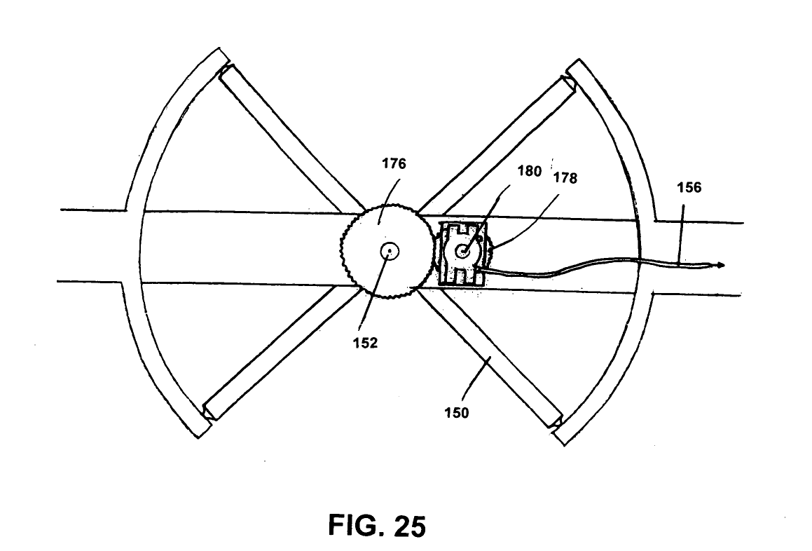

In the embodiment shown in FIG. 25 a spur gear 176 is fixed to the main shaft 152. A second spur gear 178 is fixed to the shaft of rotary pump 180 and meshed with spur gear 176. When the door 150 is rotated, the spur gears 176 and 178 cause the shaft of rotary pump 180 to rotate at a higher RPM than the door 150. This configuration can increase the air flow into the supply line 156.

In the multi-door bank embodiment shown in FIG. 26, each pumping door 182 is fitted with a single cylinder pumping mechanism 184. The pumping mechanism is similar to the one in the automatic door opener 10, but without the capability of automatic opening. Thus, the mechanical connection to the door is the same, but only one single-acting cylinder is required along with two check valves, no other valves or regulators are needed. The pneumatic schematic for this is the same as that shown in figure identical to FIG. 15.

As the doors open, they compress air into the air supply line 156, and feed it downstream into tank one of the storage tank system of the fully equipped automatic door opener 10. See FIG. 19 for an example layout description. Units 184 are pumping mechanisms with no tank system, only a pumping circuit. The air supply line 156 feeds downstream into the pressure reservoir system of the fully equipped automatic door opener 10, as shown in FIG. 19.

Generally speaking, the systems described herein are directed to automatic door openers. As required, embodiments of the present invention are disclosed herein. However, the disclosed embodiments are merely exemplary, and it should be understood that the invention may be embodied in many various and alternative forms. The Figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention. For purposes of teaching and not limitation, the illustrated embodiments are directed to automatic door openers.

As used herein, the terms “comprises” and “comprising” are to construed as being inclusive and opened rather than exclusive. Specifically, when used in this specification including the claims, the terms “comprises” and “comprising” and variations thereof mean that the specified features, steps or components are included. The terms are not to be interpreted to exclude the presence of other features, steps or components.

What is claimed as the invention is:

1. An automatic door opener attachable to at least one manual door and an automatic door having a closed position and an open position, comprising:
an opening actuator operably connected to the automatic door;
a pressure reservoir system operably connected to the opening actuator, operably connected to the manual door, and operably connected to the automatic door, whereby movement of the manual door adds pressure to the pressure reservoir system; and
a door activator having an at rest position and an open position whereby pressure from the pressure reservoir system is released to the opening actuator moving the automatic door from the closed position to the open position responsive to movement of the door activator form the at rest position to the open position.

2. An automatic door opener as claimed in claim 1 wherein the opening actuator is a pneumatic actuator.

3. An automatic door opener as claimed in claim 2 wherein the operable connection between the pneumatic actuator and the automatic door comprises a rotatable output shaft operably connected to the pneumatic actuator and a two bar linkage having one end connected to the automatic door and the other end connected to the rotatable output shaft.

4. An automatic door opener as claimed in claim 3 wherein the pneumatic actuator includes at least one linear pneumatic cylindrical actuator each having a movable piston.

5. An automatic door opener as claimed in claim 4 further including a base and wherein the linear pneumatic actuator is pivotally attached to the base and wherein the operable connection between the pneumatic actuator and the rotatable output shaft includes a lever pivotally attached to the movable piston of the pneumatic actuator at one end thereof and connected to the rotatable shaft at the other end thereof.

6. An automatic door opener as claimed in claim 4 further including a base and wherein the linear pneumatic actuator is fixedly attached to the base and wherein the operable connection between the pneumatic actuator and the rotatable output shaft includes a roller guide having one end connected to the rotatable output shaft at the one end thereof and a roller that moves freely in the roller guide being attached to the movable piston of the pneumatic cylindrical actuator.

7. An automatic door opener as claimed in claim 4 further including a base and wherein the linear pneumatic actuator is fixedly attached to the base and wherein the operable connection between the pneumatic cylindrical actuator and the rotatable output shaft includes a chain and sprocket system.

8. An automatic door opener as claimed in claim 4 further including a base and wherein the linear pneumatic actuator is fixedly attached to the base and wherein the operable connection between the pneumatic actuator and the rotatable output shaft includes a belt and pulley system.

9. An automatic door opener as claimed in claim 4 further including a base and wherein the linear pneumatic actuator is fixedly attached to the base and wherein the operable connection between the pneumatic actuator and the rotatable output shaft includes a rack and pinion system

10. An automatic door opener as claimed in claim 2 wherein the operable connection between the pneumatic actuator and the automatic door comprises a rotatable output shaft operably connected to the pneumatic actuator and a lever arm having one end connected to the rotatable output shaft and the other end movable freely in a guide track attached to the automatic door.

11. An automatic door opener as claimed in claim 2 further including a base and the pneumatic actuator is pivotally attached to the base at one end thereof and pivotally attached to the automatic door at the other end thereof.

12. An automatic door opener as claimed in claim 2 wherein the pressure reservoir system is a pneumatic pressure reservoir system.

13. An automatic door opener as claimed in claim 12 wherein the pressure reservoir system includes a plurality of air tanks connected in sequence and whereby a first air tank of the plurality of tanks has a predetermined pressure equal to the pressure required to operate the automatic door and wherein when the pressure in the first air tank is reduced pressure is added to the first tank by one of the other of the plurality of air tanks and use of the manual door.

14. An automatic door opener as claimed in claim 2 wherein the manual door and the automatic door are the same door.

15. An automatic door opener as claimed in claim 2 further including a plurality of manual swing doors each operably connected to the pressure reservoir system.

16. An automatic door opener as claimed in claim 1 wherein the manual door is a rotary door.

17. An automatic door opener as claimed in claim 16 wherein the rotary door includes a rotatable shaft operably connected to the pressure reservoir system through a pumping mechanism.

18. An automatic door opener as claimed in claim 17 wherein the pumping mechanism includes a geared crank connection to a pneumatic pump.

19. An automatic door opener as claimed in claim 17 wherein the pumping mechanism includes a direct crank connection to a pneumatic pump.

20. An automatic door opener as claimed in claim 17 wherein the pumping mechanism includes a rotary pump connected to the rotatable shaft of the rotary door.

21. An automatic door opener as claimed in claim 17 wherein the pumping mechanism includes a geared connection to a rotary pump.

22. An automatic door opener as claimed in claim 1 further including an electric system operably connected to the pressure reservoir adapted to provide pressure to the pressure reservoir system.

23. A pressure storage system for storing and providing pressure comprising;
a plurality of connected air tanks whereby when pressure is being stored and the pressure in each of the plurality of air tanks reaches a predetermined pressure level pressure will then be stored in the next adjacent air tank in the plurality of air tanks and wherein pressure is provided by a first tank in the plurality of air tanks.

24. A pressure storage system as claimed in claim 23 wherein the pressure storage system is operably connected to a device requiring pressure to operate and wherein the predetermined pressure level for the first tank of the plurality of air tanks is determined by pressure requirements of the device.
